(19) United States
(12) Patent Application Publication
(10) Pub. No.: US 2003/0161382 A1
(43) Pub. Date: Aug. 28, 2003

(54) Distributed receiver system and method

(75) Inventors: John Erik Hershey, Ballston Lake, NY (US); Harold Woodruff Tomlinson JR., Scotia, NY (US); Ralph Thomas Hoctor, Saratoga Springs, NY (US); Scott Charles Evans, Burnt Hills, NY (US); David Michael Davenport, Niskayuna, NY (US); Margaret Therese Kelliher, Scotia, NY (US); Kenneth Brakeley Welles II, Scotia, NY (US); Richard August Korkosz, Southwick, MA (US); Stephen Michael Hladik, Albany, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(73) Assignee: General Electric Company

(21) Appl. No.: 10/082,728

(22) Filed: Feb. 26, 2002

(51) Int. Cl. H04K 1/00

(52) U.S. Cl. 375/130

(57) ABSTRACT

A distributed receiver system for communicating transmitted reference ultra wideband communications signals includes a receiver front end downconverter having a correlator for producing ultra wideband pulses from the transmitted reference ultra wideband communications signals. A digitizer is connected to the receiver front end downconverter for receiving and digitizing the ultra wideband pulses. A high bandwidth cable is connected to the digitizer for receiving the digitized ultra wideband pulses. A centralized digital processing module is connected to the high bandwidth cable for interpreting the digitized ultra wideband pulses.

### STATEMENT REGARDING FEDERALLY SPONSORED RESEARCH & DEVELOPMENT

The U.S. Government may have certain rights in this invention pursuant to the National Institute of Standards and Technology (NIST) Contract Number 70ANB0H3035 awarded by NIST.

### BACKGROUND OF THE INVENTION

This invention relates to distributed receiving systems, and more particularly, to distributed receiving systems used in transmitted reference ultra wideband (TR-UWB) communications systems.

The frequency spectrum allocated for communications is becoming increasingly crowded. In order to provide service for the many communications requirements contending for the same bandwidth, it has become necessary to employ modulation techniques that permit spectral coexistence of a number of simultaneous transmissions. Spread spectrum communications is one technique that has been used to efficiently allocate the frequency spectrum for some communication applications. Typically, spread spectrum communications require more transmission bandwidth than the baseband communications that are transported. In general, the advantages to spread spectrum communications include the resistance to certain types of hostile electronic warfare jamming devices/techniques, a low probability of detection (a characteristic also of interest to the electronic warfare arts), and the ability to share the same spectrum with other contemporaneous spread spectrum users. In many spread spectrum systems, required synchronization between the transmitters and receivers is difficult.

Ultra wideband (UWB) communications is one mode of spread spectrum communications. Extremely short time duration pulses are used in UWB communications. In this technique, the shortness of the pulses allows for the ultra wide frequency content. Transmitted reference ultra wideband (TR-UWB) communications is one technique used to facilitate synchronization between the transmitter and receiver. TR-UWB communications is defined as the transmission of two versions of a wideband carrier where one version is modulated by data and the other version is unmodulated. These two signals are recovered by the receiver and are correlated with one another to perform detection of the modulating data. In this manner, synchronization between transmitters and receivers is achieved.

In the present invention, the carriers used are ultra-wideband pulses. Thus, in the present invention, the term “transmitted-reference” refers to the transmission and reception of multiple pulses in groups whose individual pulses are separated from each other by a specific time interval, known to the receiver. Typically, a TR-UWB receiver has the ability to identify the pulses that are transmitted to a particular user because, as mentioned hereinabove, more than one user can contemporaneously use the same spectrum. In one method of identifying each user, the transmissions are coded where each user is assigned a unique symbol coding scheme. For example, the symbol coding scheme can be based on a number of pulses per transmitted bit wherein the set of inter-pulse separations is different for each symbol and different for each user.

As discussed hereinabove, TR-UWB communications has the ability to support many simultaneous users within the same spectrum without requiring spectrum allocation protocols such as, for example, time division multiple access (TDMA) or frequency division multiple access (FDMA). Instead in TR-UWB communications, a low overhead random access protocol, as discussed above, can be used for many applications.

A difficulty associated with implementing spread spectrum communications is the proper demodulation of the messages from the different simultaneous users. Typically, a bank of matched filers with one filter per possible user code has been used to solve these difficulties. However, this approach requires a complete bank of filters at each receiver. Further, the requirement of a complete bank of filters at each receiver adds increased complexity and costs to the receiver. Therefore, a need exists for a spread spectrum communications apparatus that does not require a complete bank of filters at each receiver.

### BRIEF SUMMARY OF THE INVENTION

A distributed receiving system and method is provided that meliorates the synchronization and proper demodulation problems relating to conventional TR-UWB spread spectrum signaling. In one representative embodiment, a distributed receiver system is provided for communicating transmitted reference ultra wideband communications signals. The distributed receiver system comprises a receiver front end downconverter that includes a correlator for producing ultra wideband pulses from the transmitted reference ultra wideband communications signals. A plurality of digitizers receives and digitizes the ultra wideband pulses. Each of the plurality of digitizers comprises an analog to digital device for digitally converting the ultra wideband pulses, and a clock that is connected to the analog to digital device for synchronizing operations on the ultra wideband pulses. The distributed receiving system further comprises a modem connected to each of the plurality of digitizers and the clock for communicating the digitized ultra wideband pulses. In addition, a high bandwidth cable is connected to the modem for receiving the digitized ultra wideband pulses. Additionally, a centralized digital processing module is connected to the high bandwidth cable for interpreting the digitized ultra wideband pulses.

In another representative embodiment, a method for receiving and demodulating transmitted reference ultra wideband communications signals transmitted from at least one ultra wideband transmitter is provided. The method comprises the steps of receiving the transmitted reference ultra wideband communications signals using an antenna. The transmitted reference ultra wideband communications signals are downconverted into ultra wideband pulses. The ultra wideband pulses are sampled. The ultra wideband pulses are quantized into a predetermined number of quantizer levels. The ultra wideband pulses are encoded. The ultra wideband pulses are provided to a centralized digital processor. The ultra wideband pulses are processed using a logic tree to determine information content contained in the transmitted reference ultra wideband communications signals. A particular one of the ultra wideband transmitters is identified from the step of processing.

### BRIEF DESCRIPTION OF THE DRAWINGS

FIG. 1 is a block diagram view of one exemplary embodiment of a distributed receiving structure with a single digitizer;

FIG. 2 is a block diagram view of one exemplary embodiment of the receiver front end;

FIG. 3 is a block diagram view of another exemplary embodiment of a distributed receiving structure with two digitizers; and

FIG. 4 illustrates one representative embodiment of a typical logic sequence in the centralized digital processing module.

### DETAILED DESCRIPTION OF THE INVENTION

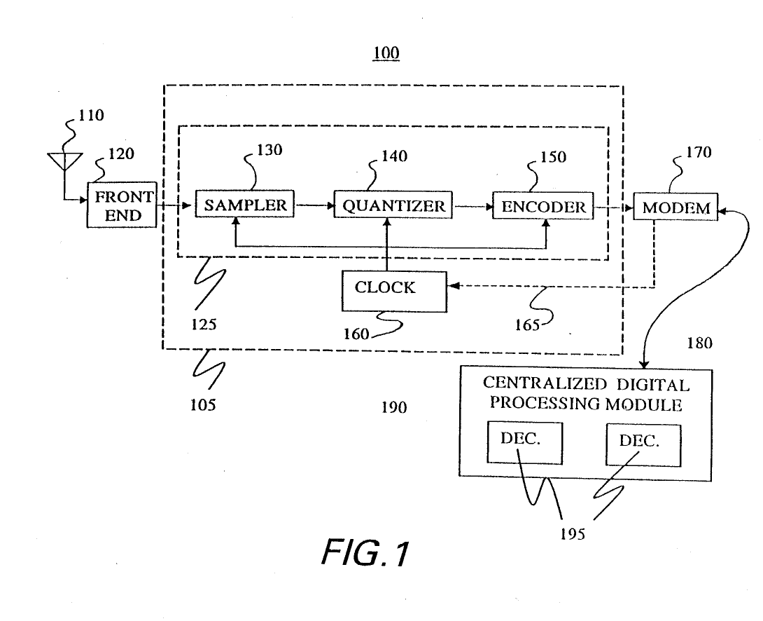

In FIG. 1, a distributed receiving system 100 can be used in transmitted reference ultra wideband (TR-UWB) communications. A remote portion of the distributed receiving system 100 includes an antenna 110 connected to a receiver front end downconverter 120. Also, a digitizer 105 is connected to the receiver front end downconverter 120. The digitizer 105 comprises an analog to digital (A-to-D) device 125 connected to the receiver front end downconverter 120 and a clock 160. The digitizer 105 is connected to a modem 170 that is connected to a centralized digital processing module 190 by a high bandwidth cable 180. In one embodiment, the requisite bandwidth supported by the high bandwidth cable 180 is on the order of the TR-UWB signaling rate. Further, in another embodiment, the bandwidth requirements of the high bandwidth cable 180 are on the order of tens of megahertz.

In one embodiment, the antenna 110 senses and receives TR-UWB communications signals. The TR-UWB communications signals are mixed with the transmitted reference in the receiver front end downconverter 120 providing, in one embodiment, downconverted ultra wideband pulse signals that are provided to the analog-to-digital (A-to-D) device 125. In one embodiment, the A-to-D device 125 comprises a sampler 130 connected to the receiver front end downconverter 120. In addition, the A-to-D device 125 includes a quantizer 140 connect-d between the sampler 130 and an encoder 150. The sampler 130, quantizer 140 and encoder 150 are each connected to clock 160. The sampler 130 samples the downconverted signals that are received from the receiver front end downconverter 120. The sampling times and/or frequencies of the A-to-D device 125 are controlled by clock 160. In one embodiment, the samples from the sampler 130 are considered to be of infinite precision and are passed to a quantizer 140 that forces each sample into one of a finite number of quantizer levels (also termed quantizer approximations). In another embodiment, the finite number of quantizer levels comprises a predetermined number of quantizer levels. In another embodiment, the quantizer 140 linear is selected from the pulse code modulation (PCM) family that is used in analog-to-digital conversion for digital signal processing. It should be appreciated that, in this embodiment, the quantizer 140 that is selected from the PCM family can comprise a mid-tread type or a mid-riser type. In even another embodiment, the quantizer 140 uses the clock 160 when quantizing the samples from the sampler 130. The quantized samples are provided to the encoder 150 that assigns code words to the quantizer levels. In one embodiment, the encoder 150 uses the clock 160 when encoding the quantized samples from the quantizer 140. The encoded quantized samples are provided to a modem 170. In addition, the modem 170 passes the encoded quantized samples via a high bandwidth cable 180 to a centralized digital processing module 190. In one embodiment, the high bandwidth cable 180 can comprise a coaxial cable or a fiber optic cable. It should also be appreciated that, in one embodiment, the high bandwidth cable 180 can function bidirectionally. Further, when functioning bidirectionally, the high bandwidth cable 180 can also transport a clock signal from the centralized digital processor 190 back to the digitizer 105 through the modem 170 via return cable 165 that is connected to the clock 160.

In one embodiment, the distributed receiving system 100 can be used for indoor communication in a building or structure. When the distributed receiving system 100 is located indoors, it may be desired to make the antenna 110 as unobtrusive as possible. Therefore, in one embodiment, the antenna 110 can be located behind a wall (not shown) or between a ceiling (not shown) and a drop ceiling (not shown). It should be appreciated that, in other embodiments, that the antenna 110 can be positioned to be hidden from view in other structures of the building.

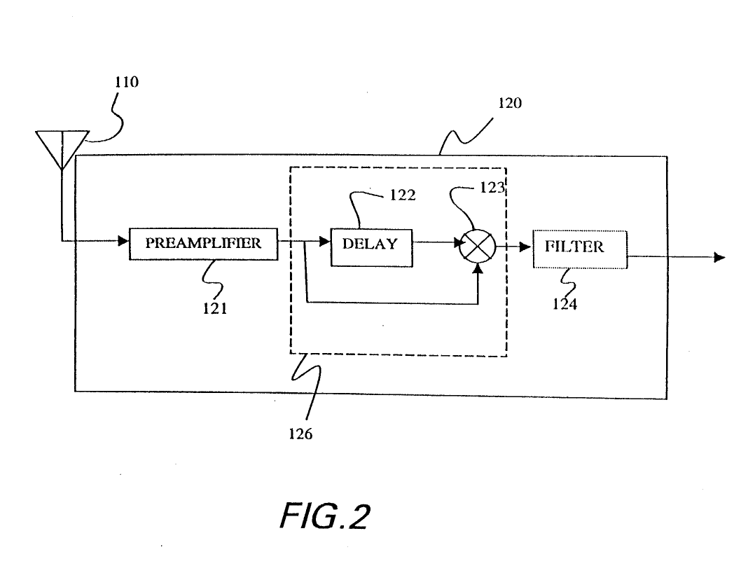

In another embodiment as shown in FIG. 2, the receiver front end downconverter 120 consists of a preamplifier 121 connected to the antenna 110. The preamplifier 121 amplifies the signals sensed by the antenna 110. The receiver front end downconverter 120 performs the function of downconverting the signals sensed by the antenna 110. The preamplifier 121 is connected to a correlator 126 that comprises a delay element 122 connected to a mixing element 123. In one embodiment, the downconversion process is commenced by first splitting the amplified signals into two paths. One path is passed through a delay element 122 that provides a delay that is equivalent to a delay from the transmitter (not shown) in forming the transmitted reference signal. The output of the delay element 122 and the output of the preamplifier 121 are combined in a mixing element 123 that is also connected to the output of the preamplifier 121. The mixing element 123 performs a multiplication of the input signals and thus produces ultra wideband downconverted pulses. In one embodiment, the output of the mixing element 123 is connected to a filter 124 for removing high frequency noise produced by the mixing operation. It should be appreciated that, in another embodiment, the filter 124 is not used in the receiver front end downconverter 120.

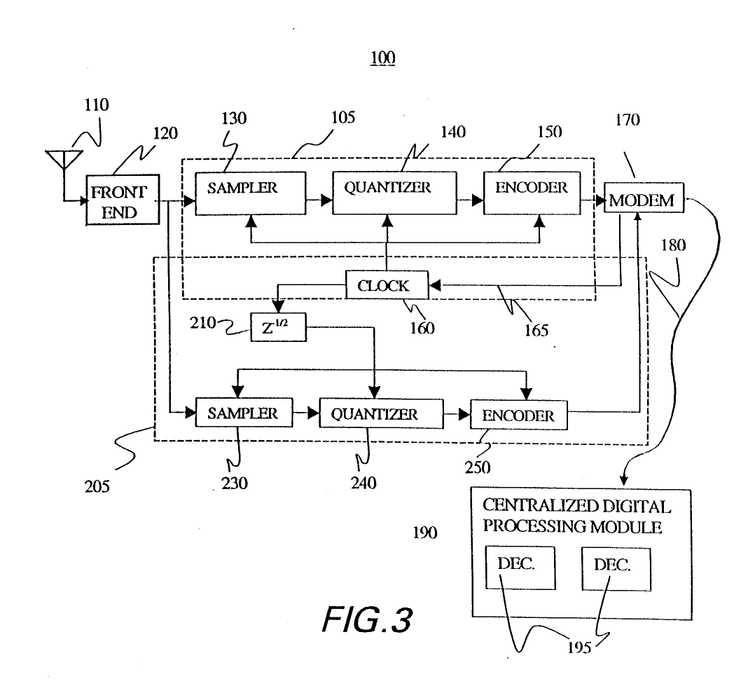

In another embodiment as shown in FIG. 3, the distributed receiving system 100 includes an additional digitizer 205 along with the digitizer 105. In this embodiment, the digitizer 205 comprises a sampler 230 connected to the receiver front end 120, and a quantizer 240 is connected between the sampler 230 and an encoder 250. In addition, the sampler 230, quantizer 240 and encoder 250 are connected to a delay element 210 that is connected to the clock 160, and the encoder 250 is connected to modem 170. The clock 160 is delayed half a sampling period by the delay element 210 that forms another clock phase for the additional digitizer 205.

In the embodiment shown in FIG. 3, the distributed receiving system 100 can sample TR-UWB communications signals at least twice as often as the embodiment shown in FIG. 1. The TR-UWB communications signal can be sampled twice as often because the distributed receiving system 100 of FIG. 3 includes the first digitizer 105 and the second digitizer 205. The first digitizer 105 has been described herein with reference to FIG. 1. The second digitizer 205 receives downconverted TR-UWB communications signals from the receiver front end downconverter 120 and samples these signals using sampler 230. In one embodiment, the sampling times and/or frequencies are controlled by the clock 160 and are delayed by one-half of a sampling period using delay element 210. In another embodiment, the samples of the TR-UWB communications signals are considered to be of infinite precision, and the samples are provided to the quantizer 240 that forces each sample into one of a finite number of quantizer levels (also termed quantizer approximations). In even another embodiment, the finite number of quantizer levels comprises a predetermined number of quantizer levels. In one embodiment, the quantizer 240 uses the timing signal from the delay element 210 when quantizing the samples from the sampler 230. The quantized samples are provided to the encoder 250. The encoder 250 assigns code words to the quantizer levels. Further, in one embodiment, the encoder 250 uses the timing signal from the delay element 210. The encoded quantized samples are provided to the modem 170 that provides the samples to the centralized digital processing module 190 via the high bandwidth cable 180. In another embodiment, the high bandwidth cable 180 can comprise a coaxial cable or a fiber optic cable. Further, in even another embodiment, the high bandwidth cable 180 can function bidirectionally and can transport a clock signal from the centralized digital processor 190 back to the first digitizer 105 and the second digitizer 205 through the modem 170 and via the return cable 165.

It should further be appreciated that other embodiments of the distributed receiving system 100 can comprise other digitizers (not shown) in addition to digitizers 105 and 205. If, in one embodiment, the distributed receiving system 100 comprised a number of digitizers “C”, each digitizer would clocked once per sample time having a delay of iτ/C where τ is the sampling period and 0≦i≦C−1.

As shown if FIGS. 1-3, the centralized digital processing module 190 consists of a plurality of decoder machines 195 for decoding and associating the decoded symbols with the proper originating user transmitters. It should be appreciated that, in one embodiment, that the decoder machine 195 can comprise elementary decoder machines. In one embodiment, a decoder machine 195 is a finite state sequential machine that is assigned to test a single hypothesis. Further, the decoder machine 195 is considered to be not in use if the decoder machine 195 is not engaged in a test. Once the decoder machine 195 is engaged, it is considered to be committed. At the conclusion of the decoder machine 195 test, the decoder machine 195 becomes available to perform another task or command. It should be appreciated that, in one embodiment, the decoder machines 195 can comprise electronic circuitry or a software program. In one embodiment, the decoder machines 195 can comprise field programmable gate array (FPGA) logic modules that operate at high speeds and have a low cost.

In one embodiment, each TR-UWB transmitter is assigned code words. Further, in another embodiment, each code word is a contiguous set of sampling periods. Each period contains a null, denoted as “0”, or an ultra wideband pulse, denoted by “P”. When a pulse is detected the centralized digital processing module 190 tests the pulse to determine if one of the defined code words is being received. When testing the pulse, the centralized digital processing module 190 identifies all possible code words that begin with “P”. The centralized digital processing module 190 assigns each hypothesis to a single elementary decoder machine 195. As further sampling periods reveal either a “0” or a “P”, some hypotheses are abandoned and others are posited. This testing process results in a dynamic allocation of decoder machines 195 wherein some decoder machines 195 are not used while others are committed.

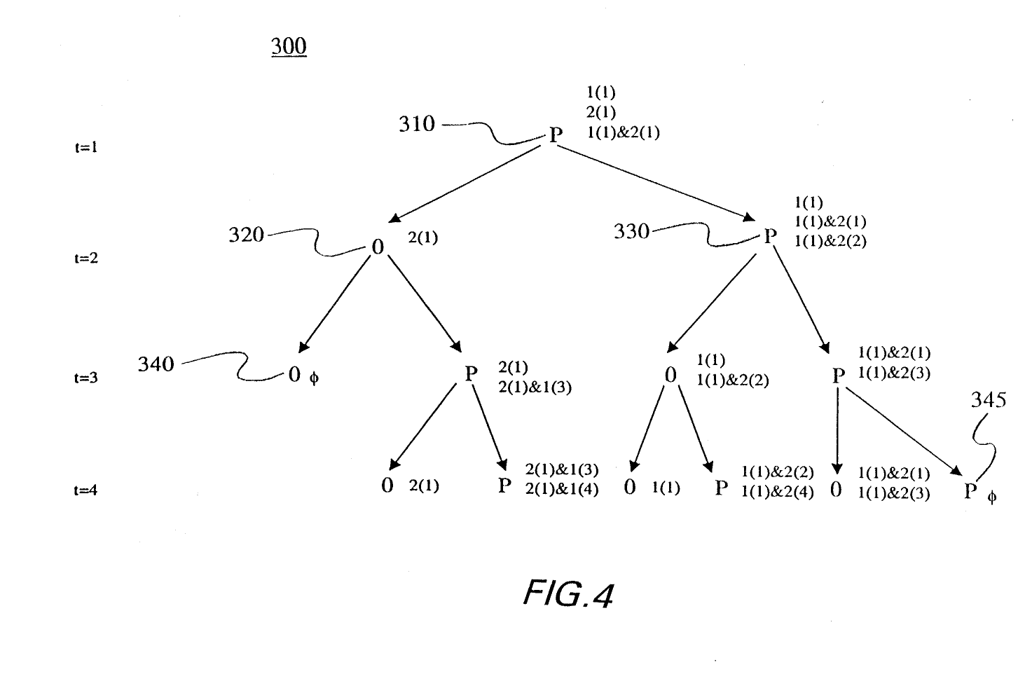

In one representative method of operation, a TR-UWB communication system comprises, for example, at least two TR-UWB transmitters, and each TR-UWB transmitter is assigned a unique code word. In one embodiment, the code words comprise “PP00” and “P0P0” . In FIG. 4, a logic sequence 300 is executed by the centralized digital processing module 190 of the distributed receiving system 100 to determine and decode the particular TR-UWB transmitter that is transmitting the TR-UWB communications signals. In the embodiment shown in FIG. 4, no TR-UWB communications signals (also termed TR-UWB pulse) are observed until time t=1. At this time, TR-UWB pulse (symbol 310) is observed denoted by “P”. The symbol 310 forms the root of a logic tree in logic sequence 300. Three hypotheses supported by the first observed TR-UWB pulse are shown in FIG. 4 to the right of the symbol 310. These hypotheses are written in shorthand using the symbol s(t) where s denotes a symbol originated at time t. In this embodiment, s=1 denotes PP00 and s=2 denotes P0P0. The hypotheses shown in FIG. 4 to the right of symbol 310 are 1(1) (that is interpreted as transmission of word 1 was commenced at t=1), 2(1) (that is interpreted as transmission of word 2 was commenced at t=1), and 1(1)&2(1) (that is interpreted as transmission of both word 1 and word 2 were commenced at t=1). At t=1, upon detection of the P symbol 310, three decoder machines 195 of the centralized digital processing module 190 are committed, one decoder machine 195 per hypothesis.

Proceeding in time to t=2, in this embodiment, two symbols may follow the P symbol at t=1. If a 0 symbol 320 is detected, then only one of the three hypotheses posited at t=1 survive. This hypothesis is 2(1). As shown in FIG. 4, this hypothesis is written to the right of the symbol 320. If the 0 symbol 320 is detected then two decoder machines 195 of the centralized digital processing module 190 are released. In this embodiment, the released decoder machines 195 are the decoder machines 195 that were keeping track of the hypotheses 1(1) and 1(1)&2(1). Thus, if 0 symbol 320 is detected, the number of committed decoder machines 195 diminishes to one decoder machine 195.

If, at t=2, a P symbol 330 is detected, then only two of the original hypotheses, 1(1) and 1(1)&2(1), are retained for further sequential testing. The other hypothesis at t=1, 2(1), is abandoned and its corresponding elementary decoder machine 195 freed only to be immediately committed to a new hypothesis: 1(1)&2(2).

As further shown in FIG. 4, the sequential testing continues in time and the hypotheses are resolved and in their resolution, the individual messages are eventually recovered. Further, it should be appreciated that not all theoretical symbol sequences can support a hypothesis. The 0 symbol 340 at t=3 is an example of such with the character φ indicating a vacuous or null set of hypotheses. A similar example is provided by the P symbol 345 at t=4.

The foregoing discussion of the invention has been presented for purposes of illustration and description. Further, the description is not intended to limit the invention to the form disclosed herein. Consequently, variations and modifications commensurate with the above teachings and with the skill and knowledge of the relevant art are within the scope of the present invention. The embodiment described herein above is further intended to explain the best mode presently known of practicing the invention and to enable others skilled in the art to utilize the invention as such, or in other embodiments, and with the various modifications required by their particular application or uses of the invention. It is intended that the appended claims be construed to include alternative embodiments to the extent permitted by the prior art.

What is claimed is:

1. A distributed receiver system for communicating transmitted reference ultra wideband communications signals, the distributed receiver system comprising:
a receiver front end downconverter comprising a correlator for producing ultra wideband pulses from the transmitted reference ultra wideband communications signals;
a digitizer connected to the receiver front end downconverter for receiving and digitizing the ultra wideband pulses;
a high bandwidth cable connected to the digitizer for receiving the digitized ultra wideband pulses; and
a centralized digital processing module connected to the high bandwidth cable for interpreting the digitized ultra wideband pulses.

2. The distributed receiver system of claim 1 further comprising an antenna connected to the receiver front end downconverter for receiving the transmitted reference ultra wideband communications signals.

3. The distributed receiver system of claim 2 wherein the antenna is configured to be positioned between a ceiling and a drop ceiling.

4. The distributed receiver system of claim 2 wherein the receiver front end downconverter further comprises a preamplifier connected to the antenna and the correlator for amplifying the received transmitted reference ultra wideband communications signals.

5. The distributed receiver system of claim 4 wherein the correlator comprises a delay element connected to the preamplifier for delaying the transmitted reference ultra wideband communications signals and a mixing element connected to the preamplifier and the delay element for mixing the delayed transmitted reference ultra wideband communication signals with the transmitted reference ultra wideband communications signals.

6. The distributed receiver system of claim 5 wherein the receiver front end downconverter further comprises filter for filtering the correlated ultra wideband communications signals.

7. The distributed receiver system of claim 1 further comprising a modem connected between the digitizer and the high bandwidth cable for supplying the digitized ultra wideband pulses to the high bandwidth cable.

8. The distributed receiver system of claim 7 wherein the digitizer further comprises:
an analog to digital device for digitally converting the ultra wideband pulses; and
a clock connected to the analog to digital device and the modem for synchronizing operations on the ultra wideband pulses.

9. The distributed receiver system of claim 8 wherein the analog to digital device further comprises:
a sampler connected to the receiver front end downconverter and the clock for sampling the ultra wideband pulses;
a quantizer connected to the sampler and the clock for quantizing the samples of the ultra wideband pulses into a predetermined number of quantizer levels; and
an encoder connected to the quantizer and the clock for encoding the quantized samples of the ultra wideband pulses.

10. The distributed receiver system of claim 1 wherein the high bandwidth cable comprises a fiber optic cable.

11. The distributed receiver system of claim 1 wherein the high bandwidth cable comprises a coaxial conductor cable.

12. The distributed receiver system of claim 1 wherein the centralized digital processing module comprises a plurality of decoder machines.

13. The distributed receiver system of claim 12 wherein each of the plurality of decoder machines comprises a field programmable gate array.

14. A distributed receiver system for communicating transmitted reference ultra wideband communications signals, the distributed receiver system comprising:
a receiver front end downconverter comprising a correlator for producing ultra wideband pulses from the transmitted reference ultra wideband communications signals;
a plurality of digitizers connected to the receiver front end downconverter for receiving and digitizing the ultra wideband pulses, each of said plurality of digitizers comprising:
an analog to digital device connected to the receiver front end downconverter for digitally converting the ultra wideband pulses; and
a clock connected to the analog to digital device for synchronizing operations on the ultra wideband pulses;
a modem connected to each of the plurality of digitizers and the clock for communicating the digitized ultra wideband pulses;
a high bandwidth cable connected to the modem for receiving the digitized ultra wideband pulses; and
a centralized digital processing module connected to the high bandwidth cable for interpreting the digitized ultra wideband pulses.

15. The distributed receiver system of claim 14 further comprising an antenna connected to the receiver front end downconverter for receiving the transmitted reference ultra wideband communications signals.

16. The distributed receiver system of claim 15 wherein said antenna is configured to be positioned between a ceiling and a drop ceiling.

17. The distributed receiver system of claim 14 wherein the analog to digital device further comprises:
a sampler connected to the receiver front end downconverter and the clock for sampling the ultra wideband pulses;
a quantizer connected to the sampler and the clock for quantizing the samples of the ultra wideband pulses into a predetermined number of quantizer levels; and
an encoder connected to the quantizer and the clock for encoding the quantized samples of the ultra wideband pulses.

18. The distributed receiver system of claim 14 wherein the high bandwidth cable comprises a fiber optic cable.

19. The distributed receiver system of claim 14 wherein the high bandwidth cable comprises a coaxial conductor cable.

20. The distributed receiver system of claim 14 wherein the centralized digital processing module comprises a plurality of decoder machines.

21. The distributed receiver system of claim 20 wherein each of the plurality of decoder machines comprises a field programmable gate array.

22. A method for receiving and demodulating spread spectrum signals, the method comprising the steps of:
sensing spread spectrum signals;
downconverting the sensed spread spectrum signals;
sampling the downconverted sensed spread spectrum signals;
quantizing the sampled spread spectrum signals;
encoding the quantized spread spectrum signals;
providing the encoded spread spectrum signals to a centralized digital processor; and
processing the transported spread spectrum signals to determine information content contained in the spread spectrum signals.

23. The method of claim 22 wherein the spread spectrum signals comprise ultra wideband communications signals.

24. The method of claims 23 wherein the ultra wideband communications signals comprise transmitted reference ultra wideband communications signals.

25. A method for receiving and demodulating transmitted reference ultra wideband communications signals transmitted from at least one ultra wideband transmitter, the method comprising the steps of:
receiving the transmitted reference ultra wideband communications signals using an antenna;
downconverting the transmitted reference ultra wideband communications signals into ultra wideband pulses;
sampling the ultra wideband pulses;
quantizing the ultra wideband pulses into a predetermined number of quantizer levels;
encoding the ultra wideband pulses;
providing the ultra wideband pulses to a centralized digital processor;
processing the ultra wideband pulses using a logic tree to determine information content contained in the transmitted reference ultra wideband communications signals; and
identifying a particular one of said at least one ultra wideband transmitter from the step of processing.
